(19) United States
(12) Patent Application Publication
(10) Pub. No.: US 2004/0193412 A1
(43) Pub. Date: Sep. 30, 2004

(54) Non-linear score scrunching for more efficient comparison of hypotheses

(75) Inventor: James K. Baker, Maitland, FL (US)

Correspondence Address: FOLEY AND LARDNER, SUITE 500, 3000 K STREET NW, WASHINGTON, DC, 20007, US

(73) Assignee: Aurilab, LLC

(21) Appl. No.: 10/389,934

(22) Filed: Mar. 18, 2003

(51) Int. Cl. G10L 15/12

(52) U.S. Cl. 704/240

(57) ABSTRACT

A speech recognition method, system, and program product, the method comprising in one embodiment: obtaining a frame match score for each of a plurality of different speech elements for a frame; obtaining a scrunched score for each of a plurality of the frame match scores for the frame, wherein a scrunched score means applying a non-linear transformation to each of the frame match scores so that frame match score differences among relatively good competing frame matches are reduced while the score differences between good frame matches and the poor frame matches is substantially maintained or increased, wherein a relatively good frame match score is determined based on a criterion; for each of a plurality of hypotheses, accumulating the scrunched scores for frames of the hypothesis to obtain a hypothesis scrunched score for the hypothesis; selecting a plurality of hypotheses with better hypothesis scrunched scores as compared to the accumulated scrunched scores for other hypotheses; for each of the selected hypotheses, determining a non-scrunched score for that hypothesis; and selecting the best hypothesis from among the selected plurality of hypotheses based at least in part on the non-scrunched scores.

### BACKGROUND

In some speech recognition search methods, in particular best first search and branch and bound methods, it is necessary to compare the scores for two hypotheses that cover different acoustic intervals. In making such comparisons, usually a missing piece evaluation is added to the match score for the shorter hypothesis. The missing piece evaluation is an estimate of the score that might be achieved on the missing piece interval by some (as yet unknown) hypothesis that contains the shorter hypothesis as a subset. There are several methods for estimating the score for the missing piece, but there is clearly a need to be able to do this estimate more accurately.

### SUMMARY OF THE INVENTION

In one embodiment of the present invention, a speech recognition method is provided, comprising: obtaining a frame match score for each of a plurality of different speech elements for a frame; obtaining a scrunched score for each of a plurality of the frame match scores for the frame, wherein a scrunched score means applying a non-linear transformation to each of the frame match scores so that frame match score differences among relatively good competing frame matches are reduced while the score differences between good frame matches and the poor frame matches is substantially maintained or increased, wherein a relatively good frame match score is determined based on a criterion; for each of a plurality of hypotheses, accumulating the scrunched scores for frames of the hypothesis to obtain a hypothesis scrunched score for the hypothesis; selecting a plurality of hypotheses with better hypothesis scrunched scores as compared to the accumulated scrunched scores for other hypotheses; for each of the selected hypotheses, determining a non-scrunched score for that hypothesis; and selecting the best hypothesis from among the selected plurality of hypotheses based at least in part on the non-scrunched scores.

In a further embodiment of the present invention, the selected best hypothesis is used in a branch-and-bound search.

In a further embodiment of the present invention, the step is provided of performing a priority queue search wherein the priority queue is sorted based on the hypothesis scrunched scores.

In a further embodiment of the present invention, the criterion for determining a good match frame score is whether the frame match score is better than a predetermined value.

In a further embodiment of the present invention, the criterion for determining a good match frame scores is to determine if a difference between a best frame score for that frame and another match frame score for that frame is less than a predetermined value.

In a further embodiment of the present invention, a speech recognition method is provided, comprising: obtaining a first table of hypothesis speech element match scores on a frame-by-frame basis; obtaining a second hypotheses table of scrunched scores processed by applying a non-linear transformation to each of a set of different hypothesis speech element frame match scores so that frame match score differences among relatively good competing frame matches are reduced while the score differences between good frame matches and the poor frame matches is substantially maintained or increased, wherein a relatively good frame match score is determined based on a criterion; for each of a plurality of hypotheses, accumulating the scrunched scores from the second table for frames of the hypothesis to obtain a hypothesis scrunched score for the hypothesis; selecting a plurality of hypotheses with better hypothesis scrunched scores as compared to the accumulated scrunched scores for other hypotheses; for each of the selected plurality of hypotheses, accumulating the frame match scores therefor on a frame-by-frame basis from the first table; and selecting a best hypothesis from among the selected plurality of hypotheses based at least in part on the accumulated match scores.

In yet a further embodiment of the present invention, a program product for speech recognition is provided, comprising machine-readable program code for causing, when executed, a machine to perform the following method steps of: obtaining a frame match score for each of a plurality of different speech elements for a frame; obtaining a scrunched score for each of a plurality of the frame match scores for the frame, wherein a scrunched score means applying a non-linear transformation to each of the frame match scores so that frame match score differences among relatively good competing frame matches are reduced while the score differences between good frame matches and the poor frame matches is substantially maintained or increased, wherein a relatively good frame match score is determined based on a criterion; for each of a plurality of hypotheses, accumulating the scrunched scores for frames of the hypothesis to obtain a hypothesis scrunched score for the hypothesis; selecting a plurality of hypotheses with better hypothesis scrunched scores as compared to the accumulated scrunched scores for other hypotheses; for each of the selected hypotheses, determining a non-scrunched score for that hypothesis; and selecting the best hypothesis from among the selected plurality of hypotheses based at least in part on the non-scrunched scores.

In a further embodiment of the present invention, a speech recognition system is provided, comprising: a component for obtaining a frame match score for each of a plurality of different speech elements for a frame; a component for obtaining a scrunched score for each of a plurality of the frame match scores for the frame, wherein a scrunched score means applying a non-linear transformation to each of the frame match scores so that frame match score differences among relatively good competing frame matches are reduced while the score differences between good frame matches and the poor frame matches is substantially maintained or increased, wherein a relatively good frame match score is determined based on a criterion; a component for, for each of a plurality of hypotheses, accumulating the scrunched scores for frames of the hypothesis to obtain a hypothesis scrunched score for the hypothesis; a component for selecting a plurality of hypotheses with better hypothesis scrunched scores as compared to the accumulated scrunched scores for other hypotheses; a component for, for each of the selected hypotheses, determining a non-scrunched score for that hypothesis; and a component for selecting the best hypothesis from among the selected plurality of hypotheses based at least in part on the non-scrunched scores.

In a yet further embodiment of the present invention, a speech recognition system is provided, comprising: means for obtaining a frame match score for each of a plurality of different speech elements for a frame; means for obtaining a scrunched score for each of a plurality of the frame match scores for the frame, wherein a scrunched score means applying a non-linear transformation to each of the frame match scores so that frame match score differences among relatively good competing frame matches are reduced while the score differences between good frame matches and the poor frame matches is substantially maintained or increased, wherein a relatively good frame match score is determined based on a criterion; means for, for each of a plurality of hypotheses, accumulating the scrunched scores for frames of the hypothesis to obtain a hypothesis scrunched score for the hypothesis; means for selecting a plurality of hypotheses with better hypothesis scrunched scores as compared to the accumulated scrunched scores for other hypotheses; means for, for each of the selected hypotheses, determining a non-scrunched score for that hypothesis; and means for selecting the best hypothesis from among the selected plurality of hypotheses based at least in part on the non-scrunched scores.

### BRIEF DESCRIPTION OF THE DRAWINGS

FIG. 1 is a block diagram of one embodiment of the present invention.

FIG. 2 is a block diagram of a further embodiment of the present invention.

### DETAILED DESCRIPTION OF EMBODIMENTS OF THE INVENTION

Definitions

The following terms may be used in the description of the invention and include new terms and terms that are given special meanings.

“Linguistic element” is a unit of written or spoken language.

“Speech element” is an interval of speech with an associated name. The name may be the word, syllable or phoneme being spoken during the interval of speech, or may be an abstract symbol such as an automatically generated phonetic symbol that represents the system's labeling of the sound that is heard during the speech interval.

“Priority queue.” in a search system is a list (the queue) of hypotheses rank ordered by some criterion (the priority). In a speech recognition search, each hypothesis is a sequence of speech elements or a combination of such sequences for different portions of the total interval of speech being analyzed. The priority criterion may be a score which estimates how well the hypothesis matches a set of observations, or it may be an estimate of the time at which the sequence of speech elements begins or ends, or any other measurable property of each hypothesis that is useful in guiding the search through the space of possible hypotheses. A priority queue may be used by a stack decoder or by a branch-and-bound type search system. A search based on a priority queue typically will choose one or more hypotheses, from among those on the queue, to be extended. Typically each chosen hypothesis will be extended by one speech element. Depending on the priority criterion, a priority queue can implement either a best-first search or a breadth-first search or an intermediate search strategy.

“Best first search” is a search method in which at each step of the search process one or more of the hypotheses from among those with estimated evaluations at or near the best found so far are chosen for further analysis.

“Breadth-first search” is a search method in which at each step of the search process many hypotheses are extended for further evaluation. A strict breadth-first search would always extend all shorter hypotheses before extending any longer hypotheses. In speech recognition whether one hypothesis is “shorter” than another (for determining the order of evaluation in a breadth-first search) is often determined by the estimated ending time of each hypothesis in the acoustic observation sequence. The frame-synchronous beam search is a form of breadth-first search, as is the multi-stack decoder.

“Frame” for purposes of this invention is a fixed or variable unit of time which is the shortest time unit analyzed by a given system or subsystem. A frame may be a fixed unit, such as 10 milliseconds in a system which performs spectral signal processing once every 10 milliseconds, or it may be a data dependent variable unit such as an estimated pitch period or the interval that a phoneme recognizer has associated with a particular recognized phoneme or phonetic segment. Note that, contrary to prior art systems, the use of the word “frame” does not imply that the time unit is a fixed interval or that the same frames are used in all subsystems of a given system.

“Frame synchronous beam search” is a search method which proceeds frame-by-frame. Each active hypothesis is evaluated for a particular frame before proceeding to the next frame. The frames may be processed either forwards in time or backwards. Periodically, usually once per frame, the evaluated hypotheses are compared with some acceptance criterion. Only those hypotheses with evaluations better than some threshold are kept active. The beam consists of the set of active hypotheses.

“Stack decoder” is a search system that uses a priority queue. A stack decoder may be used to implement a best first search. The term stack decoder also refers to a system implemented with multiple priority queues, such as a multi-stack decoder with a separate priority queue for each frame, based on the estimated ending frame of each hypothesis. Such a multi-stack decoder is equivalent to a stack decoder with a single priority queue in which the priority queue is sorted first by ending time of each hypothesis and then sorted by score only as a tie-breaker for hypotheses that end at the same time. Thus a stack decoder may implement either a best first search or a search that is more nearly breadth first and that is similar to the frame synchronous beam search.

“Branch and bound search” is a class of search algorithms based on the branch and bound algorithm. In the branch and bound algorithm the hypotheses are organized as a tree. For each branch at each branch point, a bound is computed for the best score on the subtree of paths that use that branch. That bound is compared with a best score that has already been found for some path not in the subtree from that branch. If the other path is already better than the bound for the subtree, then the subtree may be dropped from further consideration. A branch and bound algorithm may be used to do an admissible A* search. More generally, a branch and bound type algorithm might use an approximate bound rather than a guaranteed bound, in which case the branch and bound algorithm would not be admissible. In fact for practical reasons, it is usually necessary to use a non-admissible bound just as it is usually necessary to do beam pruning. One implementation of a branch and bound search of the tree of possible sentences uses a priority queue and thus is equivalent to a type of stack decoder, using the bounds as look-ahead scores.

“Admissible A* search.” The term A* search is used not just in speech recognition but also to searches in a broader range of tasks in artificial intelligence and computer science. The A* search algorithm is a form of best first search that generally includes a look-ahead term that is either an estimate or a bound on the score portion of the data that has not yet been scored. Thus the A* algorithm is a form of priority queue search. If the look-ahead term is a rigorous bound (making the procedure “admissible”), then once the A* algorithm has found a complete path, it is guaranteed to be the best path. Thus an admissible A* algorithm is an instance of the branch and bound algorithm.

“Score” is a numerical evaluation of how well a given hypothesis matches some set of observations. Depending on the conventions in a particular implementation, better matches might be represented by higher scores (such as with probabilities or logarithms of probabilities) or by lower scores (such as with negative log probabilities or spectral distances). Scores may be either positive or negative. The score may also include a measure of the relative likelihood of the sequence of linguistic elements associated with the given hypothesis, such as the a priori probability of the word sequence in a sentence.

“Dynamic programming match scoring” is a process of computing the degree of match between a network or a sequence of models and a sequence of acoustic observations by using dynamic programming. The dynamic programming match process may also be used to match or time-align two sequences of acoustic observations or to match two models or networks. The dynamic programming computation can be used for example to find the best scoring path through a network or to find the sum of the probabilities of all the paths through the network. The prior usage of the term “dynamic programming” varies. It is sometimes used specifically to mean a “best path match” but its usage for purposes of this patent covers the broader class of related computational methods, including “best path match,” “sum of paths” match and approximations thereto. A time alignment of the model to the sequence of acoustic observations is generally available as a side effect of the dynamic programming computation of the match score. Dynamic programming may also be used to compute the degree of match between two models or networks (rather than between a model and a sequence of observations). Given a distance measure that is not based on a set of models, such as spectral distance, dynamic programming may also be used to match and directly time-align two instances of speech elements.

“Best path match” is a process of computing the match between a network and a sequence of acoustic observations in which, at each node at each point in the acoustic sequence, the cumulative score for the node is based on choosing the best path for getting to that node at that point in the acoustic sequence. In some examples, the best path scores are computed by a version of dynamic programming sometimes called the Viterbi algorithm from its use in decoding convolutional codes. It may also be called the Dykstra algorithm or the Bellman algorithm from independent earlier work on the general best scoring path problem.

“Sum of paths match” is a process of computing a match between a network or a sequence of models and a sequence of acoustic observations in which, at each node at each point in the acoustic sequence, the cumulative score for the node is based on adding the probabilities of all the paths that lead to that node at that point in the acoustic sequence. The sum of paths scores in some examples may be computed by a dynamic programming computation that is sometimes called the forward-backward algorithm (actually, only the forward pass is needed for computing the match score) because it is used as the forward pass in training hidden Markov models with the Baum-Welch algorithm.

“Hypothesis” is a hypothetical proposition partially or completely specifying the values for some set of speech elements. Thus, a hypothesis is grouping of speech elements, which may or may not be in sequence. However, in many speech recognition implementations, the hypothesis will be a sequence or a combination of sequences of speech elements. Corresponding to any hypothesis is a set of models, which may, as noted above in some embodiments, be a sequence of models that represent the speech elements. Thus, a match score for any hypothesis against a given set of acoustic observations, in some embodiments, is actually a match score for the concatenation of the set of models for the speech elements in the hypothesis.

“Set of hypotheses” is a collection of hypotheses that may have additional information or structural organization supplied by a recognition system. For example, a priority queue is a set of hypotheses that has been rank ordered by some priority criterion; an n-best list is a set of hypotheses that has been selected by a recognition system as the best matching hypotheses that the system was able to find in its search. A hypothesis lattice or speech element lattice is a compact network representation of a set of hypotheses comprising the best hypotheses found by the recognition process in which each path through the lattice represents a selected hypothesis.

“Selected set of hypotheses” is the set of hypotheses returned by a recognition system as the best matching hypotheses that have been found by the recognition search process. The selected set of hypotheses may be represented, for example, explicitly as an n-best list or implicitly as the set of paths through a lattice. In some cases a recognition system may select only a single hypothesis, in which case the selected set is a one element set. Generally, the hypotheses in the selected set of hypotheses will be complete sentence hypotheses; that is, the speech elements in each hypothesis will have been matched against the acoustic observations corresponding to the entire sentence. In some implementations, however, a recognition system may present a selected set of hypotheses to a user or to an application or analysis program before the recognition process is completed, in which case the selected set of hypotheses may also include partial sentence hypotheses. Such an implementation may be used, for example, when the system is getting feedback from the user or program to help complete the recognition process.

“Look-ahead” is the use of information from a new interval of speech that has not yet been explicitly included in the evaluation of a hypothesis. Such information is available during a search process if the search process is delayed relative to the speech signal or in later passes of multi-pass recognition. Look-ahead information can be used, for example, to better estimate how well the continuations of a particular hypothesis are expected to match against the observations in the new interval of speech. Look-ahead information may be used for at least two distinct purposes. One use of look-ahead information is for making a better comparison between hypotheses in deciding whether to prune the poorer scoring hypothesis. For this purpose, the hypotheses being compared might be of the same length and this form of look-ahead information could even be used in a frame-synchronous beam search. A different use of look-ahead information is for making a better comparison between hypotheses in sorting a priority queue. When the two hypotheses are of different length (that is, they have been matched against a different number of acoustic observations), the look-ahead information is also referred to as missing piece evaluation since it estimates the score for the interval of acoustic observations that have not been matched for the shorter hypothesis.

“Missing piece evaluation” is an estimate of the match score that the best continuation of a particular hypothesis is expected to achieve on an interval of acoustic observations that was yet not matched in the interval of acoustic observations that have been matched against the hypothesis itself. For admissible A* algorithms or branch and bound algorithms, a bound on the best possible score on the unmatched interval may be used rather than an estimate of the expected score.

“Sentence” is an interval of speech or a sequence of speech elements that is treated as a complete unit for search or hypothesis evaluation. Generally, the speech will be broken into sentence length units using an acoustic criterion such as an interval of silence. However, a sentence may contain internal intervals of silence and, on the other hand, the speech may be broken into sentence units due to grammatical criteria even when there is no interval of silence. The term sentence is also used to refer to the complete unit for search or hypothesis evaluation in situations in which the speech may not have the grammatical form of a sentence, such as a database entry, or in which a system is analyzing as a complete unit an element, such as a phrase, that is shorter than a conventional sentence.

“Pruning” is the act of making one or more active hypotheses inactive based on the evaluation of the hypotheses. Pruning may be based on either the absolute evaluation of a hypothesis or on the relative evaluation of the hypothesis compared to the evaluation of some other hypothesis.

“Pruning threshold” is a numerical criterion for making decisions of which hypotheses to prune among a specific set of hypotheses.

“Pruning margin” is a numerical difference that may be used to set a pruning threshold. For example, the pruning threshold may be set to prune all hypotheses in a specified set that are evaluated as worse than a particular hypothesis by more than the pruning margin. The best hypothesis in the specified set that has been found so far at a particular stage of the analysis or search may be used as the particular hypothesis on which to base the pruning margin.

“Beam width” is the pruning margin in a beam search system. In a beam search, the beam width or pruning margin often sets the pruning threshold relative to the best scoring active hypothesis as evaluated in the previous frame.

“Best found so far” Pruning and search decisions may be based on the best hypothesis found so far. This phrase refers to the hypothesis that has the best evaluation that has been found so far at a particular point in the recognition process. In a priority queue search, for example, decisions may be made relative to the best hypothesis that has been found so far even though it is possible that a better hypothesis will be found later in the recognition process. For pruning purposes, hypotheses are usually compared with other hypotheses that have been evaluated on the same number of frames or, perhaps, to the previous or following frame. In sorting a priority queue, however, it is often necessary to compare hypotheses that have been evaluated on different numbers of frames. In this case, in deciding which of two hypotheses is better, it is necessary to take account of the difference in frames that have been evaluated, for example by estimating the match evaluation that is expected on the portion that is different or possibly by normalizing for the number of frames that have been evaluated. Thus, in some systems, the interpretation of best found so far may be based on a score that includes a look-ahead score or a missing piece evaluation.

“Modeling” is the process of evaluating how well a given sequence of speech elements match a given set of observations typically by computing how a set of models for the given speech elements might have generated the given observations. In probability modeling, the evaluation of a hypothesis might be computed by estimating the probability of the given sequence of elements generating the given set of observations in a random process specified by the probability values in the models. Other forms of models, such as neural networks may directly compute match scores without explicitly associating the model with a probability interpretation, or they may empirically estimate an a posteriori probability distribution without representing the associated generative stochastic process.

“Grammar” is a formal specification of which word sequences or sentences are legal (or grammatical) word sequences. There are many ways to implement a grammar specification. One way to specify a grammar is by means of a set of rewrite rules of a form familiar to linguistics and to writers of compilers for computer languages. Another way to specify a grammar is as a state-space or network. For each state in the state-space or node in the network, only certain words or linguistic elements are allowed to be the next linguistic element in the sequence. For each such word or linguistic element, there is a specification (by a labeled arc in the network, for example) as to what the state of the system will be at the end of that next word (by following the arc to the node at the end of the arc, for example). A third form of grammar representation is as a database of all legal sentences.

“Pass.” A simple speech recognition system performs the search and evaluation process in one pass, usually proceeding generally from left to right, that is, from the beginning of the sentence to the end. A multi-pass recognition system performs multiple passes in which each pass includes a search and evaluation process similar to the complete recognition process of a one-pass recognition system. In a multi-pass recognition system, the second pass may, but is not required to be, performed backwards in time. In a multi-pass system, the results of earlier recognition passes may be used to supply look-ahead information for later passes.

The invention is described below with reference to drawings. These drawings illustrate certain details of specific embodiments that implement the systems and methods and programs of the present invention. However, describing the invention with drawings should not be construed as imposing, on the invention, any limitations that may be present in the drawings. The present invention contemplates methods, systems and program products on any computer readable media for accomplishing its operations. The embodiments of the present invention may be implemented using an existing computer processor, or by a special purpose computer processor incorporated for this or another purpose or by a hardwired system.

As noted above, embodiments within the scope of the present invention include program products comprising machine-readable media for carrying or having machine-executable instructions or data structures stored thereon. Such machine-readable media can be any available media which can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also be included within the scope of machine-readable media. Machine-executable instructions comprise, for example, instructions and data which cause a general purpose computer, special purpose computer, or special purpose processing machines to perform a certain function or group of functions.

Embodiments of the invention will be described in the general context of method steps which may be implemented in one embodiment by a program product including machine-executable instructions, such as program code, executed by computers in networked environments. Generally, program modules include routines, programs, objects, components, data structures, etc. that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a conventional computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to removable optical disk such as a CD-ROM or other optical media. The drives and their associated machine-readable media provide nonvolatile storage of machine-executable instructions, data structures, program modules and other data for the computer.

Rather than supplying a new method for estimating missing piece scores, this invention provides a method for transforming scores so that it is easier for existing estimation methods to estimate missing pieces more accurately. This improvement is especially important for speech recognition tasks with a large complex grammar. Not only does such a grammar make it difficult to estimate the score for the missing piece, but it makes an accurate estimate more important. With a large complex grammar, either an over estimate or an under estimate can make the search unsuccessful.

If the missing piece score is estimated to be better than the actual score, then the search will incorrectly prefer shorter hypotheses. If the search spends all its time searching short hypotheses, it may fail to find the correct longer hypothesis. On the other hand, if the missing piece score is estimated to be worse than the actual score, then the search may prefer an incorrect longer hypothesis and never return to a shorter hypothesis that is a prefix for the correct hypothesis. Any improvement in the accuracy of the estimates of the missing piece score will help with both of these problems, but it is clear that any additional reduction of the severity of this problem would be valuable. The technique of this invention is complementary to methods for estimating the missing piece score. It can be used in combination with methods for estimating the missing piece score without interference.

When two hypotheses of different length are compared for sorting a priority queue, it is sufficient to estimate the expected score on the missing piece. When evaluating the bound in an admissible branch and bound search, it is necessary to use a strict upper bound on the score that may be achieved on the missing piece. A further valuable property of the technique of this invention is that it also helps in comparing hypotheses in a branch and bound algorithm.

This invention works by transforming the scores that are used to measure the degree of match between hypotheses and the acoustic observations. The hypotheses with these transformed scores may then be sorted or a group therefrom selected based on the transformed scores. Then a standard search algorithm can be applied to the task of searching to find the best scoring sequence of elements (hypothesis) among the hypothesis group selected in accordance with the transformed scores. In particular, the transformed scores are not used as an approximation to the original scores in the original search task. Rather a search is done just with the transformed scores. There is never a need to compare one hypothesis evaluated with untransformed scores to another hypothesis evaluated with transformed scores.

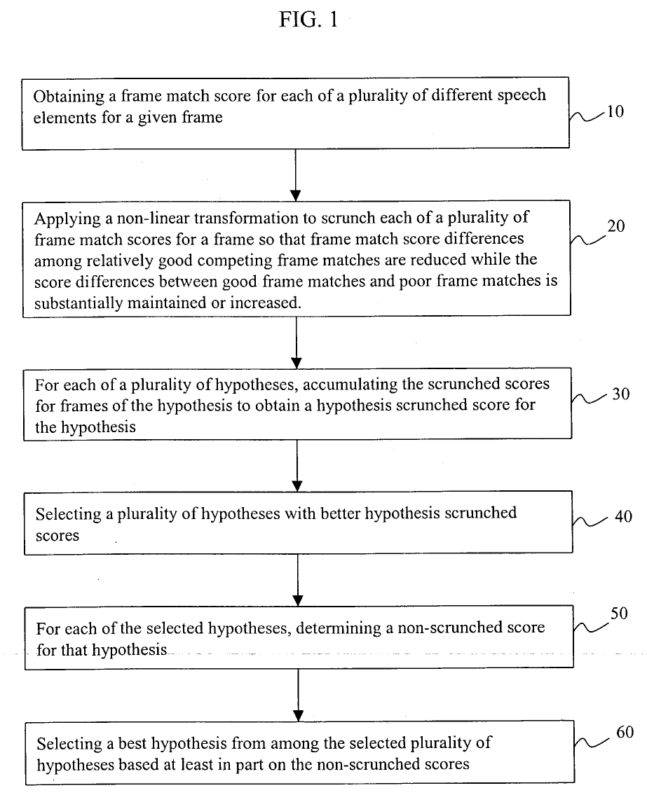

Referring to FIG. 1, a block diagram flowchart of one embodiment of a speech recognition method and program product consistent with the present invention is shown. In block 10 a match score for each of a plurality of frames is obtained. This score may, in one embodiment, be a probability that acoustic data for a frame is a particular phoneme, for example a probability of 0.8, or 0.1, or 0.001. In many cases, these probabilities will be represented by their logarithms.

Referring to block 20, a scrunched score is obtained for each of the plurality of frames or acoustic segments, wherein a scrunched score means applying a non-linear transformation to the scores to simplify the task of estimating the score for a missing piece. This non-linear transformation may be based on a function that depends only on the score value itself, or it may be based on a more complex computation such as a comparison between the score for one phoneme hypothesis and another. The non-linear transformation is designed to decrease the difference among the scores of the relatively good scoring hypotheses while substantially maintaining or increasing the difference in scores between good hypotheses and poor hypotheses. More specifically, the non-linear function is applied to each of a set of frame match scores for different speech elements so that frame match score differences among relatively good competing frame matches are reduced while the score differences between good frame matches and the poor frame matches is substantially maintained or increased, wherein a relatively good frame match score is determined based on a criterion;

As an example, such a non-linear transformation could be the function f(x) defined by

f(x)=0, if |x|<delta; otherwise f(x)=x, (1)

where delta is a predetermined value. In this example, the criterion is that the absolute value of the score is less than delta.

As an another example, let the best score of any phoneme for frame t be Best(t), then an example of the non-linear transformation could be computed as

f(x,t)=0 if|Best(t)−x|<delta; otherwise f(x)=x, (2)

where delta is a predetermined value. In this example, the criterion is that a difference between a best frame score for that frame and another match frame score for that frame is less than a predetermined value.

Two examples of scrunching are provided in the following tables.

The example in the first table is a frame of acoustic data y for which the best phoneme match is the phoneme /EE/. The table shows the other phoneme hypotheses that are the next best matches to the acoustic data y. For each phoneme hypothesis, the table shows the system's estimate of the conditional probability P(y|phoneme=x). In one embodiment, the search algorithm would use the logarithm of this estimated probability as the score for the degree of match between the phoneme hypothesis x and the observed acoustic data y. These logarithms are shown in the next line in the table. In one example scrunching method, the non-linear transformation is merely to replace any score that is greater than −4.0 by 0 (that is, use delta=4.0 in equation (1)). In the second example method for each of the tables, each score is compared with the best score on that frame for any phoneme. If the score difference is less than 3.5 (that is, use delta=3.5 in equation (2)), the score is replaced by a score of 0.

The tables show the effects of these two score scrunching methods on two example frames. In the first example the acoustic frame best matches the phoneme /EE/. In the second example, the acoustic frame best matches the phoneme /AW/. Because the phoneme /EE/ matches the acoustic frame in the first example of Table 1 very well, the two scrunching rules have the same effect in this example. The scores for /EE/, /IH/, and /EH/ are scrunched to 0 by both scrunching rules.

In the second example shown in Table 2, the best matching phoneme /AW/ only matches the acoustic frame moderately well. In this example, the first scrunching rule replaces the scores of the phonemes /AW/, /IAA/, and /OH/ with a score of 0. The second scrunching rule also replaces the scores of the phonemes /UH/ and /OO/ with a score of 0.

TABLE 1
OF ACOUSTIC DATA SIMILAR TO EE

| | Phoneme x = | | | | | | |
|---|---|---|---|---|---|---|---|
| | EE | IH | EH | EI | AI | UU | AX |
| Probabilities | .75 | .1 | .1 | .05 | .01 | .005 | .005 |
| Log of Probab. | −0.4 | −3.3 | −3.3 | −4.3 | −6.6 | −7.6 | −7.6 |
| Scrunched | 0 | 0 | 0 | −4.3 | −6.6 | −7.6 | −7.6 |
| Score1 | | | | | | | |
| Scrunched | 0 | 0 | 0 | −4.3 | −6.6 | −7.6 | −7.6 |
| Score2 | | | | | | | |

TABLE OF ACOUSTIC DATA SIMILAR TO AW

| | Phoneme x = | | | | | | |
|---|---|---|---|---|---|---|---|
| | AW | AA | OH | UH | OO | AE | EH |
| Probabilities | .4 | .3 | .15 | .05 | .05 | .01 | .01 |
| Log of Probab. | −1.3 | −1.7 | −2.7 | −4.3 | −4.3 | −6.6 | −6.6 |
| Scrunched | 0 | 0 | 0 | −4.3 | −4.3 | −6.6 | −6.6 |
| Score1 | | | | | | | |
| Scrunched | 0 | 0 | 0 | 0 | 0 | −6.6 | −6.6 |
| Score2 | | | | | | | |

Referring to block 30, for each of a plurality of hypotheses, the scrunched scores for the frames of the hypothesis are accumulated to obtain a hypothesis scrunched score.

Referring to block 40, a selection is made of a plurality of hypotheses with better hypothesis scrunched scores as compared to the accumulated scrunched scores for other hypotheses. As an example, this selection could be made by performing a search of the set of hypotheses using a priority queue search or stack decoder. In this example, the priority queue or stack could be sorting in part based on comparisons of hypotheses that have been matched against different numbers of acoustic frames. The scrunched scores would facilitate the missing piece evaluation required for such comparisons. As a second example, this selection of a plurality of better hypotheses could be made by performing a branch-and-bound search of the set of hypotheses. In this example, the scrunched scores would facilitate estimating accurate and tight bounds for the unevaluated portion of the sentence.

Referring to block 50, for each of the selected hypotheses, determining a non-scrunched score for that hypothesis.

Referring to block 60, selecting the best hypothesis from among the selected plurality of hypotheses based at least in part on the non-scrunched scores.

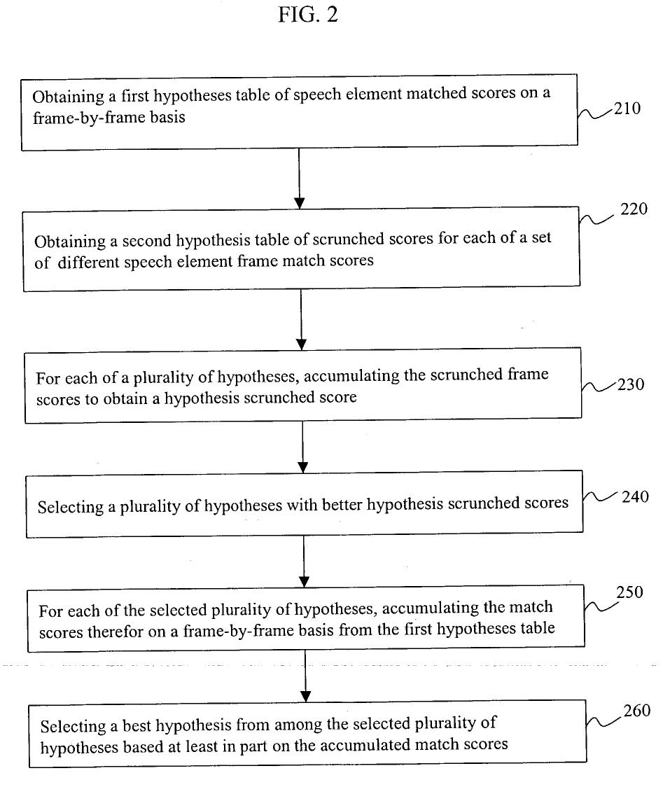

A further embodiment of the speech recognition method and program product is shown in FIG. 2. Referring to block 200, a first table is obtained of hypothesis speech element match scores on a frame-by-frame basis.

Referring to block 210, a second hypotheses table is obtained of scrunched scores processed by applying a non-linear transformation to each of a set of different hypothesis speech element frame match scores so that frame match score differences among relatively good competing frame matches are reduced while the score differences between good frame matches and the poor frame matches is substantially maintained or increased, wherein a relatively good frame match score is determined based on a criterion. In one embodiment, the second hypothesis table of scrunched scores is obtained by performing the non-linear transformation on elements of the first hypothesis table.

Referring to block 220, for each of a plurality of hypotheses, the scrunched scores from the second table for frames of the hypothesis are accumulated to obtain a hypothesis scrunched score for the hypothesis.

Referring to block 230, a selection is made of a plurality of hypotheses with better hypothesis scrunched scores as compared to the accumulated scrunched scores for other hypotheses. As an example, this selection could be made by performing a search of the set of hypotheses using a priority queue search or stack decoder. In this example, the priority queue or stack could be sorting in part based on comparisons of hypotheses that have been matched against different numbers of acoustic frames. The scrunched scores would facilitate the missing piece evaluation required for such comparisons. As a second example, this selection of a plurality of better hypotheses could be made by performing a branch-and-bound search of the set of hypotheses. In this example, the scrunched scores would facilitate estimating accurate and tight bounds for the unevaluated portion of the sentence.

Referring to block 240, for each of the selected plurality of hypotheses, the frame match scores therefor on a frame-by-frame basis from the first table are accumulated.

Referring to block 250, a selection is made of a best hypothesis from among the selected plurality of hypotheses based at least in part on the accumulated match scores.

The following examples show a further aspect of this invention, in particular, the benefit of scrunching to zero or another low number many of the scores for the correct hypothesis. In the first example, a longer correct hypothesis is being compared with a shorter incorrect hypothesis. The unscrunched scores are logarithms of probabilities (multiplied by −10 to give integer values for the example).

| H1 | AW | S | T | IH | N | DH | AX | K | AE | P | IH | T | AX | L | AH | V | T | EH | K | S | IH | S |
|---|---|---|---|---|---|---|---|---|---|---|---|---|---|---|---|---|---|---|---|---|---|---|
| Scores | 15 | 5 | 15 | 23 | 18 | 23 | 23 | 15 | 10 | 18 | 18 | 15 | 23 | 46 | 46 | 23 | 15 | 12 | 18 | 05 | 25 | 05 |
| Scrunched | 0 | 0 | 0 | 0 | 0 | 0 | 0 | 0 | 0 | 0 | 0 | 0 | 0 | 46 | 46 | 0 | 0 | 0 | 0 | 0 | 0 | 0 |

| H2 | R | IH | CH | M | AX | N | D |
|---|---|---|---|---|---|---|---|
| Scores | 88 | 56 | 33 | 66 | 43 | 18 | 33 |
| Scrunched | 88 | 56 | 0 | 66 | 0 | 0 | 0 |

The longer correct hypothesis “Austin the capital of Texas” is compared to the shorter incorrect hypothesis “Richmond.” In the example, the /L/ of “capital” and the /AH/ of “of” match poorly, so their scores don't get scrunched. In comparing the hypotheses using the match scores, the total accumulated score for the longer correct hypothesis is worse (because we have multiplied the logarithms of the probabilities by −10, larger scores are worse), even though the shorter hypothesis matches worse for the shorter portion. In a match search, the shorter hypothesis “Richmond” would need to be extended repeatedly during the search until it was extended to the hypothesis “Richmond the capital of Virginia” because the next few words “the capital of” match equally well for both hypotheses. Many other short hypotheses would also need to be extended during the search, greatly increasing the amount of computation.

When the hypotheses are compared using the scrunched scores, however, the hypothesis “Richmond” is immediately seen to be worse than the hypothesis “Austin the capital of Texas.”

In other examples, however, the scrunching will cause some incorrect hypotheses that are close to the correct hypothesis to score just as well as the correct hypothesis, because the difference gets scrunched. Since both hypotheses score well, they will both be found by the search process. The rescoring of block 240 in FIG. 2, then will cause the selection of block 250 to select the correct hypothesis.

In the second example, the longer incorrect hypothesis “Boston the capital of Massachusetts” is compared to the shorter correct hypothesis “Austin.”

| H1 | B | AW | S | T | AX | N | DH | AX | K | AE | P | IH | T | AX | L | AH | V | M | AE | S | AH | CH |
|---|---|---|---|---|---|---|---|---|---|---|---|---|---|---|---|---|---|---|---|---|---|---|
| Scores | 23 | 15 | 05 | 15 | 23 | 18 | 23 | 23 | 15 | 10 | 18 | 18 | 15 | 46 | 46 | 23 | 23 | 66 | 43 | 05 | 33 | 53 |
| Scrunched | 0 | 0 | 0 | 0 | 0 | 0 | 0 | 0 | 0 | 0 | 0 | 0 | 0 | 46 | 46 | 0 | 0 | 0 | 0 | 0 | 0 | 0 |

| H2 | AW | S | T | AX | N |
|---|---|---|---|---|---|
| Scores | 23 | 05 | 15 | 23 | 18 |
| Scrunched | 0 | 0 | 0 | 0 | 0 |

In this second example, the shorter correct hypothesis would correctly be extended whether the hypotheses were compared using match scores or scrunched scores. Thus the selection of better scrunched score hypotheses in block 240 will cause the selection in block 260 to select the correct hypothesis even though there is no difference in scrunched scores between the correct hypothesis and the similar incorrect hypothesis.

However, if instead of scrunching, the scores were adjusted, for example, by subtracting an estimate of the average score per frame from each score (as done in the prior art), then the longer hypothesis might get a negative score, causing the shorter, correct, hypothesis not to be extended. Thus the score scrunching facilitates the process of searching for the best hypotheses, while block 250 allows the final selection of the best hypothesis to still be based on the match scores. In particular, the long segments of zero scores will allow much tighter bounds for hypotheses of different lengths.

Note that the “scrunched” scores are not intended to maintain the difference in score between the best scoring hypothesis and other hypotheses, or even the rank order. The scrunched scores are used to facilitate the search process, but are not used to make the final selection of the best hypothesis. A lattice or an n-best list of the best scoring hypotheses found in the search with “scrunched” scores is rescored with standard scores, so the final selection is based on standard scores.

It should be noted that although the flow charts provided herein show a specific order of method steps, it is understood that the order of these steps may differ from what is depicted. Also two or more steps may be performed concurrently or with partial concurrence. Such variation will depend on the software and hardware systems chosen and on designer choice. It is understood that all such variations are within the scope of the invention. Likewise, software and web implementations of the present invention could be accomplished with standard programming techniques with rule based logic and other logic to accomplish the various database searching steps, correlation steps, comparison steps and decision steps. It should also be noted that the word “component” as used herein and in the claims is intended to encompass implementations using one or more lines of software code, and/or hardware implementations, and/or equipment for receiving manual inputs.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

1. A speech recognition method, comprising:
obtaining a frame match score for each of a plurality of different speech elements for a frame;
obtaining a scrunched score for each of a plurality of the frame match scores for the frame, wherein a scrunched score means applying a non-linear transformation to each of the frame match scores so that frame match score differences among relatively good competing frame matches are reduced while the score differences between good frame matches and the poor frame matches is substantially maintained or increased, wherein a relatively good frame match score is determined based on a criterion;
for each of a plurality of hypotheses, accumulating the scrunched scores for frames of the hypothesis to obtain a hypothesis scrunched score for the hypothesis;
selecting a plurality of hypotheses with better hypothesis scrunched scores as compared to the accumulated scrunched scores for other hypotheses;
for each of the selected hypotheses, determining a non-scrunched score for that hypothesis; and
selecting the best hypothesis from among the selected plurality of hypotheses based at least in part on the non-scrunched scores.

2. The method as defined in claim 1, further comprising performing a branch-and-bound search based on the hypothesis scrunched scores.

3. The method as defined in claim 1, further comprising performing a priority queue search wherein the priority queue is sorted based on the hypothesis scrunched scores.

4. The method as defined in claim 1, wherein the criterion for determining a good match frame score is whether the frame match score is better than a predetermined value.

5. The method as defined in claim 1, wherein the criterion for determining a good match frame scores is to determine if a difference between a best frame score for that frame and another match frame score for that frame is less than a predetermined value.

6. A speech recognition method, comprising:
obtaining a first table of hypothesis speech element match scores on a frame-by-frame basis;
obtaining a second hypotheses table of scrunched scores processed by applying a non-linear transformation to each of a set of different hypothesis speech element frame match scores so that frame match score differences among relatively good competing frame matches are reduced while the score differences between good frame matches and the poor frame matches is substantially maintained or increased, wherein a relatively good frame match score is determined based on a criterion;
for each of a plurality of hypotheses, accumulating the scrunched scores from the second table for frames of the hypothesis to obtain a hypothesis scrunched score for the hypothesis;
selecting a plurality of hypotheses with better hypothesis scrunched scores as compared to the accumulated scrunched scores for other hypotheses;
for each of the selected plurality of hypotheses, accumulating the frame match scores therefor on a frame-by-frame basis from the first table; and
selecting a best hypothesis from among the selected plurality of hypotheses based at least in part on the accumulated match scores.

7. The method as defined in claim 6, further comprising generating the second hypotheses table by performing the non-linear transformation on frame match scores in the first hypotheses table.

8. A program product for speech recognition, comprising machine-readable program code for causing, when executed, a machine to perform the following method steps of:
obtaining a frame match score for each of a plurality of different speech elements for a frame;
obtaining a scrunched score for each of a plurality of the frame match scores for the frame, wherein a scrunched score means applying a non-linear transformation to each of the frame match-scores so that frame match score differences among relatively good competing frame matches are reduced while the score differences between good frame matches and the poor frame matches is substantially maintained or increased, wherein a relatively good frame match score is determined based on a criterion;
for each of a plurality of hypotheses, accumulating the scrunched scores for frames of the hypothesis to obtain a hypothesis scrunched score for the hypothesis;
selecting a plurality of hypotheses with better hypothesis scrunched scores as compared to the accumulated scrunched scores for other hypotheses;
for each of the selected hypotheses, determining a non-scrunched score for that hypothesis; and
selecting the best hypothesis from among the selected plurality of hypotheses based at least in part on the non-scrunched scores.

9. The program product as defined in claim 8, further comprising program code for performing a branch-and-bound search using the hypothesis scrunched scores.

10. The program product as defined in claim 8, further comprising program code for performing a priority queue search wherein the priority queue is sorted based on the hypothesis scrunched scores.

11. The program product as defined in claim 8, wherein the criterion for determining a good match frame score is whether the frame match score is better than a predetermined value.

12. The program product as defined in claim 8, wherein the criterion for determining a good match frame scores is to determine if a difference between a best frame score for that frame and another match frame score for that frame is less than a predetermined value.

13. A speech recognition system, comprising:
a component for obtaining a frame match score for each of a plurality of different speech elements for a frame;
a component for obtaining a scrunched score for each of a plurality of the frame match scores for the frame, wherein a scrunched score means applying a non-linear transformation to each of the frame match scores so that frame match score differences among relatively good competing frame matches are reduced while the score differences between good frame matches and the poor frame matches is substantially maintained or increased, wherein a relatively good frame match score is determined based on a criterion;
a component for, for each of a plurality of hypotheses, accumulating the scrunched scores for frames of the hypothesis to obtain a hypothesis scrunched score for the hypothesis;
a component for selecting a plurality of hypotheses with better hypothesis scrunched scores as compared to the accumulated scrunched scores for other hypotheses;
a component for, for each of the selected hypotheses, determining a non-scrunched score for that hypothesis; and
a component for selecting the best hypothesis from among the selected plurality of hypotheses based at least in part on the non-scrunched scores.

14. A speech recognition system, comprising:
means for obtaining a frame match score for each of a plurality of different speech elements for a frame;
means for obtaining a scrunched score for each of a plurality of the frame match scores for the frame, wherein a scrunched score means applying a non-linear transformation to each of the frame match scores so that frame match score differences among relatively good competing frame matches are reduced while the score differences between good frame matches and the poor frame matches is substantially maintained or increased, wherein a relatively good frame match score is determined based on a criterion;
means for, for each of a plurality of hypotheses, accumulating the scrunched scores for frames of the hypothesis to obtain a hypothesis scrunched score for the hypothesis;
means for selecting a plurality of hypotheses with better hypothesis scrunched scores as compared to the accumulated scrunched scores for other hypotheses;
means for, for each of the selected hypotheses, determining a non-scrunched score for that hypothesis; and
means for selecting the best hypothesis from among the selected plurality of hypotheses based at least in part on the non-scrunched scores.
